(19) United States
(12) Patent Application Publication
(10) Pub. No.: US 2021/0069727 A1
(43) Pub. Date: Mar. 11, 2021

(54) MAGNETIC SEPARATOR

(71) Applicant: SUMITOMO HEAVY INDUSTRIES FINETECH, LTD., Okayama (JP)

(72) Inventor: Shinya Nishizawa, Okayama (JP)

(21) Appl. No.: 17/103,390

(22) Filed: Nov. 24, 2020

Related U.S. Application Data
(63) Continuation of application No. 15/822,896, filed on Nov. 27, 2017.

(30) Foreign Application Priority Data
Dec. 1, 2016 (JP) 2016-234072

(51) Int. Cl. B03C 1/12; B03C 1/32; B03C 1/033; B03C 1/14

(52) U.S. Cl. CPC B03C 1/12; B03C 1/32; B03C 2201/18; B03C 1/14; B03C 1/0332

(57) ABSTRACT

A magnetic separator includes: a scraper configured to channel a liquid through an opening portion to a flow pathway, the scraper extends from a sub-drum to the opening portion; a first bottom wall configured to channel the liquid along the flow pathway in a manner that channels the liquid away from the opening portion, the flow pathway is between a main drum and a curved surface of the first bottom wall; and a second bottom wall configured to channel the liquid along a lower flow path in a manner that channels the liquid to the opening portion, the lower flow path is between the sub-drum and a curved surface of the second bottom wall.

### RELATED APPLICATIONS

This is a continuation of U.S. patent application Ser. No. 15/822,896 filed on Nov. 27, 2017, the contents of which, including the specification, the claim and the drawings, are incorporated herein by reference in their entirety. Priority is claimed to Japanese Patent Application No. 2016-234072, filed Dec. 1, 2016, the entire content of which is incorporated herein by reference in their entirety.

### BACKGROUND

### Technical Field

Certain embodiments of the present invention relate to a magnetic separator for recovering magnetic sludge such as metal components contained in a liquid to be treated. More specifically, the embodiments of the present invention relate to a magnetic separator provided with a main drum for recovering magnetic sludge from a liquid to be treated, and a sub-drum disposed upstream of the main drum and magnetizing the magnetic sludge.

### Description of Related Art

As metalworking machines, there are working machines using magnetic metal as a material to be cut, and cutting oil containing cuttings is discharged from such a metalworking machine. Then, as cutting treatment apparatuses for separating the cuttings from such cutting oil, magnetic separators are known. The magnetic separator is provided with a rotary drum having magnets disposed on the outer periphery thereof, and the cuttings are separated from the cutting oil by adsorbing the cuttings by the rotary drum. Among them, a technique for improving a recovery rate by providing a sub-drum with a function of magnetizing magnetic bodies has attracted attention.

For example, the related art discloses a rotary drum type magnetic separation apparatus provided with a first rotary drum (a main drum) in which a plurality of magnets are disposed, and a second rotary drum (a sub-drum) disposed upstream of the first rotary drum. According to this apparatus, the second rotary drum is provided with a function of magnetizing magnetic bodies, whereby the magnetic bodies adsorbed to the second rotary drum are magnetized and attracted to each other to form large particles. Then, the large particles are easily guided to the first rotary drum and can be reliably recovered by the first rotary drum.

### SUMMARY

According to an embodiment of the present invention, there is provided a magnetic separator that includes: a scraper configured to channel a liquid through an opening portion to a flow pathway, the scraper extends from a sub-drum to the opening portion; a first bottom wall configured to channel the liquid along the flow pathway in a manner that channels the liquid away from the opening portion, the flow pathway is between a main drum and a curved surface of the first bottom wall; and a second bottom wall configured to channel the liquid along a lower flow path in a manner that channels the liquid to the opening portion, the lower flow path is between the sub-drum and a curved surface of the second bottom wall.

### BRIEF DESCRIPTION OF THE DRAWINGS

FIG. 1 is a schematic explanatory diagram showing a structure of a magnetic separator according to one embodiment of the present invention.

FIG. 2 is a schematic explanatory diagram showing detailed structures of a second scraper and an opening portion of the magnetic separator according to one embodiment of the present invention.

FIG. 3 is a schematic explanatory diagram for explaining a liquid feeding direction in the opening portion of the magnetic separator according to one embodiment of the present invention.

FIG. 4A is a schematic explanatory diagram for explaining stirring action between a sub-drum and a main drum in the magnetic separator according to one embodiment of the present invention, and FIG. 4B is an enlarged view of a region E in FIG. 4A.

FIG. 5 is a schematic explanatory diagram showing structures of the cross sections (X-X line cross section in FIG. 1) of the sub-drum, an upper flow path, and a lower flow path of the magnetic separator according to one embodiment of the present invention.

FIG. 6 is a graph showing a recovery rate in a case where a coolant liquid is treated by using a magnetic separator, in which A in the graph is a graph showing a recovery rate in a magnetic separator of the related art, which is not provided with a sub-drum, and B in the graph is a graph showing a recovery rate in the magnetic separator according to one embodiment of the present invention.

FIG. 7 is a schematic explanatory diagram showing a structure of a magnetic separator according to another embodiment of the present invention.

### DETAILED DESCRIPTION

It is desirable to further improve a recovery rate of magnetic sludge in a magnetic separator provided with a main drum which discharges the magnetic sludge to the outside of a liquid to be treated, and a sub-drum which is disposed on the upstream side of the main drum and magnetizes the magnetic sludge in the liquid to be treated to form magnetized aggregates.

As a result of intensive study, the inventor of the present invention has found that the recovery rate of the magnetic sludge is improved by providing flow paths, through which the liquid to be treated flows, above and below the sub-drum immersed in the liquid to be treated, and has completed the present invention.

That is, the present invention provides the following magnetic separator.

According to this magnetic separator, the liquid to be treated flows through both the upper side and the lower side of the sub-drum, and therefore, it is possible to magnetically attract the magnetic sludge by using the entire circumference of the sub-drum. For this reason, the amount of magnetized aggregates which are formed at the sub-drums increases. The magnetized aggregate is larger than the magnetic sludge before aggregation, and therefore, it becomes easy to receive the magnetic force of the main drum, and thus magnetic attraction to the main drum is promoted. The magnetic separator according to an embodiment of the present invention exhibits the effect of improving the recovery rate of the magnetic sludge, based on such action. Further, the magnetic sludge magnetically attracted to the sub-drum in the lower flow path has a longer magnetization time, and therefore, the effect of the sub-drum forming the magnetized aggregates is still further exerted.

Further, the liquid to be treated which flows above the sub-drum exhibits the operational effect of transferring the magnetic sludge magnetically attracted to the sub-drum to the main drum of the subsequent stage.

As an embodiment of the magnetic separator according to the present invention, the liquid to be treated flowing through the upper flow path may pass between the sub-drum and the main drum and then form a flow which flows below the main drum, and the liquid to be treated flowing through the lower flow path may be guided toward a region between the sub-drum and the main drum and join a flow of the liquid to be treated from the upper flow path.

According to this feature, the flow of the liquid to be treated containing the magnetic sludge flowing through the upper flow path and the liquid to be treated flowing through the lower flow path join each other between the sub-drum and the main drum, and therefore, stirring action occurs in the region between the sub-drum and the main drum. Therefore, the magnetic sludge in the liquid to be treated flows through the region between the sub-drum and the main drum, and therefore, the opportunity for the magnetic sludge to approach the main drum increases, and thus the effect that the magnetic sludge is easily magnetically attracted to the main drum is exhibited.

As an embodiment of the magnetic separator according to the present invention, a flow rate of the liquid to be treated in the lower flow path may be larger than a flow rate of the liquid to be treated in the upper flow path.

If the flow rate of the liquid to be treated in the lower flow path is made larger than the flow rate of the liquid to be treated in the upper flow path, the amount of magnetic sludge flowing on the lower flow path side increases, and therefore, a lot of magnetic sludge is magnetically attracted to the sub-drum in the lower flow path. Therefore, the time for magnetization becomes longer, and thus the effect of easily forming the magnetized aggregates is exhibited.

Further, even in the above-described stirring action between the sub-drum and the main drum, stirring action in an upward direction becomes stronger, and therefore, the opportunity for the magnetic sludge to approach the main drum still further increases, and thus the magnetic sludge is easily magnetically attracted.

As an embodiment of the magnetic separator according to the present invention, the magnetic separator may further include: a scraper having one end being in contact with the sub-drum and the other end disposed and fixed on the main drum side; and an opening portion which is disposed on the other end side of the scraper and sends the liquid to be treated in the lower flow path to the main drum.

According to this feature, the scraper for the sub-drum is disposed to extend from the sub-drum to the main drum side, and therefore, the magnetic sludge scraped off by one end of the scraper flows to the main drum side along the scraper. Then, if the magnetic sludge reaches the other end side of the scraper, it flows in the direction of the main drum by the liquid to be treated from the opening portion disposed on the other end side of the scraper. Therefore, the opportunity for the magnetic sludge to approach the main drum further increases, and thus the effect that the magnetic sludge is easily magnetically attracted to the main drum is exhibited.

As an embodiment of the magnetic separator according to the present invention, the opening portion may send the liquid to be treated in the lower flow path in a direction of rotation of the main drum.

According to this feature, the magnetic sludge flows along the direction of rotation of the main drum, and therefore, the magnetic attraction of the magnetic sludge to the main drum can be further promoted.

As an embodiment of the magnetic separator according to the present invention, the sub-drum may include an outer cylinder fixed to a main body of the magnetic separator, and an inner cylinder having a plurality of magnets disposed at intervals on an outer peripheral surface, and the inner cylinder may rotate in a direction opposite to a flow direction of the liquid to be treated flowing through the lower flow path.

According to this feature, the plurality of magnets are disposed at intervals in the circumferential direction on the outer peripheral surface of the inner cylinder, and therefore, a region having a strong magnetic force and a region having a weak magnetic force are alternately formed on the outer peripheral surface of the outer cylinder. For this reason, the magnetic sludge is magnetically attracted at intervals in the circumferential direction to the outer peripheral surface of the outer cylinder. The magnetic sludge magnetically attracted to the outer peripheral surface of the outer cylinder moves in the circumferential direction of the outer cylinder due to the inner cylinder rotating in the direction opposite to the flow direction of the liquid to be treated flowing through the lower flow path, and is scraped off by the scraper for the sub-drum. The magnetic sludge which has reached the scraper stays at an end portion of the scraper due to the magnetic force until the region having a strong magnetic force passes through the end portion of the scraper, and forms a large magnetized aggregate. Then, when the region having a weak magnetic force passes through the end portion of the scraper, the magnetic sludge is peeled off from the scraper as the large magnetized aggregate and moves in the direction of the main drum. With such action, the magnetized aggregate of the magnetic sludge can be made larger, and therefore, the magnetic attraction to the main drum can be performed more reliably.

According to the present invention, it is possible to provide a magnetic separator which is a magnetic separator provided with a main drum which discharges magnetic sludge to the outside of a liquid to be treated, and a sub-drum which is disposed on the upstream side of the main drum and magnetizes the magnetic sludge in the liquid to be treated, and has excellent performance of recovering the magnetic sludge.

A magnetic separator according to embodiments of the present invention is for recovering magnetic sludge contained in a liquid to be treated, by a magnetic force. As the liquid to be treated in the present invention, there is no particular limitation as long as it is a liquid containing magnetic sludge, and it may be an oily liquid or a water-soluble liquid. As a general liquid to be treated, for example, a coolant liquid in a metal grinding machine using magnetic metal as a workpiece, a plating solution in an apparatus for performing plating on a steel sheet or the like, or the like can be given. The magnetic separator according to an embodiment of the present invention can recover the magnetic sludge from these liquids to be treated, thereby cleaning the liquid to be treated. In addition, the magnetic separator according to an embodiment of the present invention can also be used for, for example, recovery of rare metal from industrial waste, removal of foreign matter from a beverage, edible oil, or the like.

Hereinafter, embodiments of the present invention will be described in detail with reference to the accompanying drawings.

### One Embodiment

### Magnetic Separator

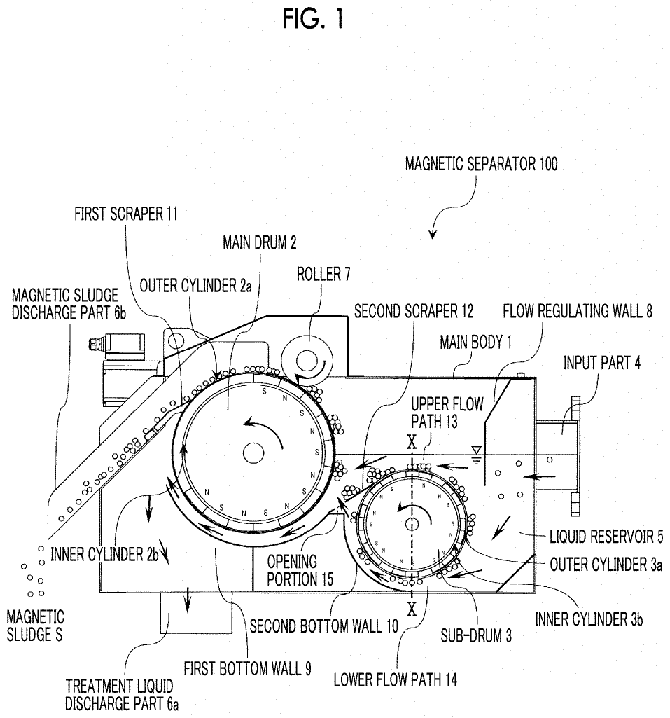

FIG. 1 shows the structure of a magnetic separator 100 according to one embodiment of the present invention. The magnetic separator 100 according to an embodiment of the present invention is provided with a main body 1 composed of a substantially rectangular housing, an input part 4 for inputting a liquid to be treated containing magnetic sludge into the main body 1, a treatment liquid discharge part 6a for discharging a treatment liquid with the magnetic sludge removed therefrom, and a magnetic sludge discharge part 6b for discharging the magnetic sludge. Further, a liquid reservoir 5 for storing the liquid to be treated is provided in the interior of the main body 1, and the interior of the main body 1 is configured so as to be able to store the liquid to be treated to a predetermined water level.

The input part 4 is provided on the one end side (the right side in FIG. 1) of the main body 1, and the treatment liquid discharge part 6a and the magnetic sludge discharge part 6b are provided on the other end side (the left side in FIG. 1) of the main body 1. Then, the liquid to be treated input from the input part 4 is configured so as to flow in a direction of the treatment liquid discharge part 6a through the liquid reservoir 5.

A main drum 2 which magnetically attracts the magnetic sludge and discharges it to the outside of the liquid to be treated, and a sub-drum 3 which is disposed on the upstream side of the main drum 2 and magnetizes the magnetic sludge in the liquid to be treated to form magnetized aggregates are provided in the interior of the main body 1. The sub-drum 3 is disposed in a state of being immersed in the liquid to be treated, and an upper flow path 13 and a lower flow path 14, through which the liquid to be treated flows, are formed above and below the sub-drum 3.

A flow regulating wall 8 is provided in the interior of the main body 1 to be separated from an inlet of the input part 4. The flow regulating wall 8 actively guides the flow of the input liquid to be treated in a direction of the lower flow path 14 to promote the magnetic attraction of the magnetic sludge in the lower flow path 14. Further, the flow of the liquid to be treated having a high flow velocity, which has flowed in from the input part 4, is restricted due to the installation of the flow regulating wall 8, and therefore, it is possible to reduce the amount of magnetic sludge passing through the upper flow path 13 without being magnetized by the sub-drum 3.

### Main Drum

The main drum 2 is a rotary drum supported substantially horizontally in a direction orthogonal to the flow of the liquid to be treated. The main drum 2 is installed such that an approximately half the circumference on the lower side is immersed under the liquid surface of the liquid to be treated and an approximately half the circumference on the upper side comes out from the liquid surface.

The main drum 2 is composed of a rotatably supported outer cylinder 2a, and an inner cylinder 2b having a plurality of magnets disposed on an outer peripheral surface thereof. The inner cylinder 2b having the plurality of magnets is fixed to the inside of the outer cylinder. The direction of rotation of the outer cylinder 2a is a direction opposite to the flow of the liquid to be treated which passes below the outer cylinder 2a (a counterclockwise when viewed from the plane of FIG. 1).

The polarities of the plurality of magnets disposed on the inner cylinder 2b are disposed such that it is possible to magnetically attract the magnetic sludge by generating a predetermined magnetic flux on the outer peripheral surface of the outer cylinder. In the magnetic separator 100 of one embodiment, as shown in FIG. 1, the magnet having a north pole and the magnet having a south pole are alternately disposed. Further, the plurality of magnets are disposed over the portion of approximately two-thirds of the outer peripheral surface of the inner cylinder 2b, and magnets are not disposed on the portion of the remaining approximately one-third such that no magnetic force acts thereon.

The outer cylinder 2a is rotated, whereby the main drum 2 can discharge the magnetic sludge magnetically attracted to the outer peripheral surface of the outer cylinder 2a to the outside of the liquid to be treated. The configuration of the main drum is not particularly limited as long as it is a configuration in which the magnetic sludge in the liquid to be treated is magnetically attracted by the magnetic force and the magnetically attracted magnetic sludge can be transported to the outside of the liquid to be treated, and for example, a configuration may be adopted in which magnets are disposed on the inner peripheral surface of the outer cylinder and the outer cylinder provided with the magnets is rotated, or a configuration may be adopted in which the outer cylinder is fixed and the inner cylinder provided with magnets is rotated.

In the vicinity of the top portion of the main drum 2, a roller 7 is installed further on the rear side in the direction of rotation than the top portion, and a first scraper 11 is installed further on the front side in the direction of rotation than the top portion.

The roller 7 has an elastic body such as rubber disposed on the surface thereof and is in contact with the outer peripheral surface of the outer cylinder 2a of the main drum 2 with a predetermined pressing force. The magnetically attracted magnetic sludge passes between the outer cylinder 2a and the roller 7, whereby the liquid component of the magnetic sludge is squeezed out, and therefore, the magnetic sludge with less liquid component can be separated and recovered.

As the elastic body disposed on the surface of the roller 7, an elastic body such as CR (chloroprene) rubber or NBR (nitrile) rubber is mainly used. However, for example, a un-crosslinked polyurethane material containing polyester polyol as a main component thereof may be used.

The first scraper 11 is in contact with the outer peripheral surface of the outer cylinder 2a of the main drum 2 and is configured to scrape off the magnetic sludge, the liquid component of which has been squeezed out by the roller 7, from the outer peripheral surface of the outer cylinder 2a. The first scraper 11 is provided in an area where the magnets of the inner cylinder 2b are not disposed.

A first bottom wall 9 is installed below the main drum 2 to be separated from the outer periphery of the main drum 2. The shape of the first bottom wall 9 is a shape along the outer periphery of the main drum, and a flow path through which the liquid to be treated flows is formed between the main drum 2 and the first bottom wall 9. The first bottom wall 9 is provided, whereby the liquid to be treated passes through the vicinity of the outer periphery of the main drum 2, and therefore, it is possible to promote the magnetic attraction of the magnetic sludge.

The magnetic sludge magnetically attracted to the outer periphery of the main drum 2 is transported onto the liquid surface while being magnetically attracted to the circumference of the outer cylinder 2a, due to the rotation of the outer cylinder 2a, and the liquid component is squeezed out by the roller 7. Further, if the magnetic sludge is transported to the area where the magnets are not disposed, the magnetic sludge is released from the magnetic force and scraped off by the first scraper 11. The scraped magnetic sludge is discharged from the magnetic sludge discharge part 6b to the outside of the main body 1.

### Sub-Drum

The sub-drum 3 is a rotary drum having a smaller diameter than the main drum 2 and is disposed on the upstream side of the main drum 2 (the front side in the flow direction of the liquid to be treated). The sub-drum 3 is disposed in a state of being immersed in the liquid to be treated, and the upper flow path 13 through which the liquid to be treated flows is formed above the sub-drum 3, and the lower flow path 14 through which the liquid to be treated flows is formed below the sub-drum 3.

The structure of the sub-drum 3 is composed of an outer cylinder 3a fixed so as to penetrate the main body 1, and an inner cylinder 3b having a plurality of magnets disposed on the outer peripheral surface thereof, and the inner cylinder 3b having the plurality of magnets is rotatably fixed inside the outer cylinder 3a. The direction of rotation is a direction opposite to the flow direction of the liquid to be treated flowing through the lower flow path 14 (a counterclockwise when viewed from the plane of FIG. 1). Further, the outer cylinder 3a is fixed in a liquid-tight state with respect to the wall of the main body 1 and configured such that the liquid to be treated does not flow in toward the side of the inner cylinder 3b which is rotationally driven. According to this configuration, the liquid does not come into contact with a rotation mechanism of the inner cylinder 3b, and therefore, problems such as failure of the rotation mechanism can be reduced. Further, it is possible to prevent the liquid to be treated from leaking between the outer cylinder 3a and the wall of the main body 1 to the outside of the main body 1. The above configuration of the sub-drum 3 is an example, and similar to the main drum 2, there is no particular limitation as long as it is a configuration capable of magnetically attracting the magnetic sludge in the liquid to be treated by the magnetic force and transporting it on the circumference of the outer cylinder 3a.

The disposition of the magnets of the sub-drum 3 is made such that even-numbered sets (8 sets) of magnet groups, in each of which the magnet having a south pole and the magnet having a north pole are adjacent to each other, are disposed, as shown in FIG. 1. The magnet groups adjacent to each other are disposed such that the same poles face each other with a gap therebetween. With such an array, a region in which a magnetic attraction force is weak is formed between the magnet groups adjacent to each other.

Further, the magnets disposed on the opposite sides of the sub-drum 3 are disposed such that the same poles face each other.

Further, similar to the main drum 2, a second bottom wall 10 having a shape along the outer periphery of the sub-drum 3 is installed below the sub-drum 3 to be separated from the outer periphery of the sub-drum 3. In this way, the effect of promoting the magnetic attraction of the magnetic sludge to the sub-drum 3 is exhibited.

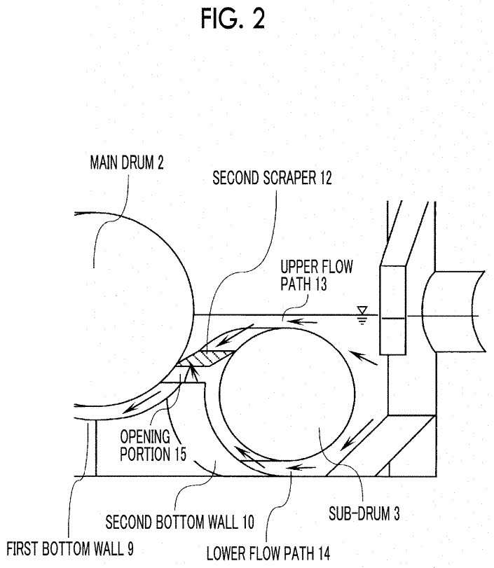

A second scraper 12 for scraping off the magnetic sludge magnetically attracted to the sub-drum 3 is provided in the vicinity of the top portion of the sub-drum 3. One end of the second scraper 12 is in contact with the sub-drum 3, and the other end extends to the main drum 2 side and is welded and fixed to the first bottom wall 9. Further, an opening portion 15 for sending the liquid to be treated in the lower flow path 14 in the direction of rotation of the main drum 2 is formed on the other end side of the second scraper 12. The detailed structures of the second scraper 12 and the opening portion 15 are shown in FIG. 2.

In one embodiment, the opening portion 15 is configured with an opening which is open on the end portion side of the second scraper 12. However, any configuration may be adopted as long as the liquid to be treated in the lower flow path 14 can be sent toward the main drum 2. For example, a gap between the other end of the second scraper and the first bottom wall 9 may be used as an opening portion without fixing the other end of the second scraper to the first bottom wall 9, the opening portion may be configured with a mesh having openings, or a nozzle having an opening area which gradually reduces may be provided.

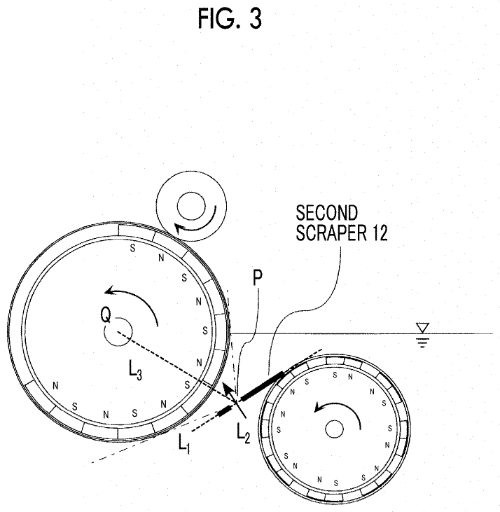

Here, a liquid feeding direction in the opening portion 15 will be described with reference to FIG. 3. The liquid feeding direction in the opening portion 15 is a direction of a perpendicular line (an arrow L₂ in FIG. 3) passing through the center (P in FIG. 3) of a plane (a broken line L₁ in FIG. 3) configuring the opening portion 15.

Then, the opening portion for sending the liquid to be treated from the lower flow path 14 to the main drum 2 means a configuration in which the liquid feeding direction (L₂) in the opening portion is directed within the range of the tangent line (a dashed-dotted line in FIG. 3) of the main drum 2 passing through the center P of the opening portion.

Further, the opening portion for sending the liquid to be treated from the lower flow path 14 in the direction of rotation of the main drum 2 means a configuration in which the liquid feeding direction (L₂) in the opening portion is directed further forward in the direction of rotation of the main drum 2 than a line (a broken line L₃ in FIG. 3) passing through the center (Q in FIG. 3) of the main drum 2 and the center P of the opening portion.

Next, the operation of the upper flow path 13 and the lower flow path 14 will be described in detail while describing the flow of the liquid to be treated. The flow of the liquid to be treated is indicated by arrows in FIGS. 1 and 2.

The liquid to be treated containing the magnetic sludge input from the input part 4 is changed into a downward flow by the flow regulating wall 8 and stored in the liquid reservoir 5. The liquid to be treated stored in the liquid reservoir 5 flows to be divided to the upper flow path 13 and the lower flow path 14, and therefore, it is possible to magnetically attract the magnetic sludge using the entire circumference of the sub-drum 3. The magnetic sludge magnetically attracted to the sub-drum 3 is magnetized and attracted to each other, so that fine particles gather to form magnetized aggregates. If the magnetic sludge becomes a large magnetized aggregate, it becomes easy to receive the magnetic force, and thus the effect of promoting the magnetic attraction to the main drum 2 is exhibited, so that the recovery rate of the magnetic sludge is improved. Further, since the magnetic sludge magnetically attracted to the sub-drum 3 in the lower flow path 14 has a longer magnetization time, a larger magnetized aggregate is formed, and therefore, it is possible to further promote the magnetic attraction at the main drum 2.

The magnetic sludge magnetically attracted to the sub-drum 3 moves in a circumferential direction of the sub-drum due to the rotation of the magnet in the circumferential direction of the sub-drum and is scraped off by the end portion of the second scraper 12. At that time, the magnetic sludge which has moved to the end portion of the second scraper 12 stays at the end portion of the second scraper 12 by the magnetic force until the area where the magnet is disposed passes through the end portion of the second scraper 12, and forms a large magnetized aggregate. Then, when the area where the magnet is not disposed passes through the end portion of the second scraper 12, the large magnetized aggregate composed of the magnetic sludge is peeled off from the second scraper 12 and moves in the direction of the main drum 2. With such action, the magnetized aggregate of the magnetic sludge can be made larger, and therefore, the magnetic attraction to the main drum 2 can be performed more reliably.

The liquid to be treated which has passed through the upper flow path 13 then passes between the sub-drum 3 and the main drum 2 and subsequently forms a flow flowing below the main drum 2. The magnetized aggregate of the magnetic sludge scraped off by the second scraper 12 is transported to the main drum 2 side along with this flow and magnetically attracted to the main drum 2. Then, the treatment liquid from which the magnetic sludge has been removed at the main drum 2 moves toward the treatment liquid discharge part 6a and is discharged to the outside of the main body 1.

On the other hand, the liquid to be treated which has passed through the lower flow path 14 is also guided toward the region between the sub-drum 3 and the main drum 2 and joins the flow from the upper flow path 13. In this way, stirring action occurs in the region between the sub-drum 3 and the main drum 2. The liquid to be treated from the lower flow path 14 contains little magnetic sludge.

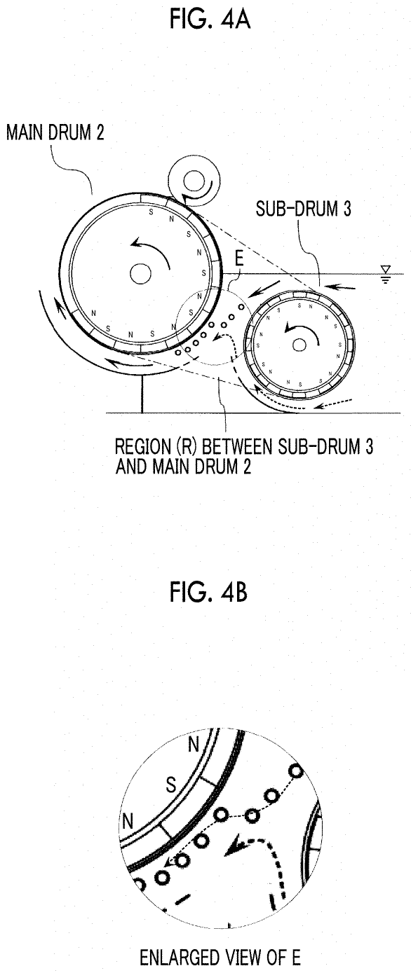

FIGS. 4A and 4B show schematic explanatory diagrams for explaining this stirring action. As shown in FIGS. 4A and 4B, the liquid to be treated which has passed through the upper flow path 13 passes between the sub-drum 3 and the main drum 2 and then flows between the main drum 2 and the first bottom wall 9 (solid line arrows in FIG. 4A). Further, the liquid to be treated which has passed through the lower flow path 14 is guided to the region (R) between the sub-drum 3 and the main drum 2 by the second bottom wall 10 and joins the flow from the upper flow path 13 (a broken line arrow in FIG. 4A). The region (R) between the sub-drum 3 and the main drum 2 is the region between a line connecting the respective tangent lines on the upper side of the sub-drum 3 and the main drum 2 and a line (a dashed-dotted line in FIG. 4A) connecting the respective tangent lines on the lower side.

As shown in FIG. 4B, if the liquid to be treated from the lower flow path 14 joins the flow from the upper flow path 13, the magnetic sludge contained in the flow from the upper flow path 13 is subjected to the action of causing it to flow upward. For this reason, the opportunity for the magnetic sludge to approach the main drum 2 increases, and thus the effect that the magnetic sludge is easily magnetically attracted to the main drum 2 is exhibited.

In the magnetic separator 100 of one embodiment, the liquid to be treated from the lower flow path 14 joins the flow from the upper flow path 13 through the opening portion 15. The liquid feeding direction in the opening portion 15 is set so as to send the liquid to be treated in the lower flow path 14 in the direction of rotation of the main drum 2, and therefore, the magnetic sludge can flow toward the main drum 2.

In order to obtain the stirring action by joining, the opening portion 15 may not be provided and a configuration may be adopted in which a guiding member capable of guiding the liquid to be treated from the lower flow path 14 to the region (R) between the sub-drum 3 and the main drum 2 is provided.

The flow rate of the liquid to be treated flowing through each of the upper flow path 13 and the lower flow path 14 is appropriately set such that the magnetic sludge can be magnetically attracted to the sub-drum 3, while taking into consideration the magnetic attraction force of the sub-drum 3, or the like. From the viewpoint of prolonging the magnetization time of the magnetic sludge, it is preferable to make the flow rate of the liquid to be treated in the lower flow path 14 larger than the flow rate of the liquid to be treated in the upper flow path 13. Further, by making the flow rate of the liquid to be treated in the lower flow path 14 larger, when the liquid to be treated from the lower flow path 14 joins the flow from the upper flow path 13, the magnetic sludge strongly flows, and thus there is also the effect of further increasing the opportunity for the magnetic sludge to approach the main drum 3.

Here, the flow rate of the liquid to be treated flowing through the lower flow path 14 is determined by the cross-sectional area of the lower flow path 14 or the minimum cross-sectional area of the opening area of the opening portion 15. Further, the flow rate of the liquid to be treated flowing through the upper flow path 13 can be adjusted by the flow rate of the liquid to be treated which is input from the input part 4.

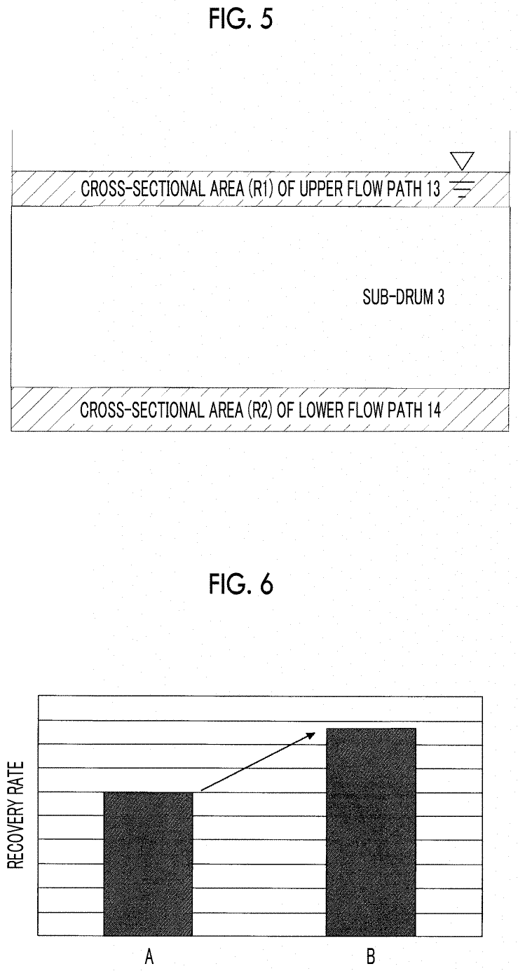

FIG. 5 shows a vertical sectional view (along dashed-dotted line X-X in FIG. 1) at the center of the sub-drum 3. The minimum cross-sectional area of the upper flow path 13 is the cross-sectional area (R1) of the flow path immediately above the sub-drum 3, and therefore, the minimum cross-sectional area (R1) of the upper flow path 13 varies according to the height of the liquid surface. For example, if the minimum cross-sectional area of the lower flow path 14 is set to be the cross-sectional area (R2) of the flow path immediately below the sub-drum 3, by adjusting the height of the liquid surface (the input amount of the liquid to be treated from the input part 4) such that the relationship of R2>R1 is satisfied, it is possible to make the flow rate of the liquid to be treated in the lower flow path 14 larger than the flow rate of the liquid to be treated in the upper flow path 13.

In the flow rate adjustment described above, the adjustment is performed according to the operating conditions. However, the minimum cross-sectional area of the upper flow path 13 may be set to be constant by providing a flow rate adjustment part such as a wall above the sub-drum 3.

FIG. 6 is a graph showing a recovery rate in a case where a coolant liquid is treated by using the magnetic separator 100 of one embodiment. A in the graph is a graph showing a recovery rate in a magnetic separator of the related art which is not provided with a sub-drum, and B in the graph is a graph showing a recovery rate in the magnetic separator 100 according to one embodiment of the present invention.

From the graph, it can be seen that the recovery rate in the magnetic separator according to an embodiment of the present invention is about 1.5 times higher than that in the magnetic separator of the related art which is not provided with a sub-drum.

### Another Embodiment

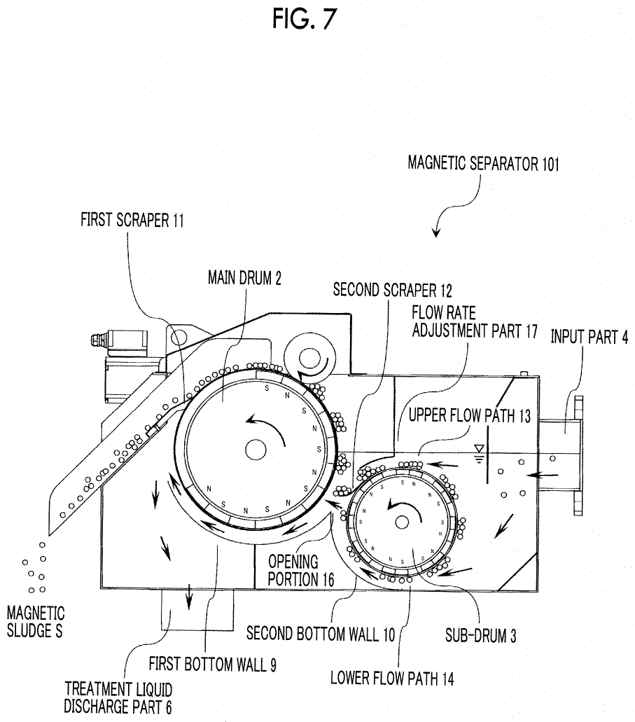

FIG. 7 shows the structure of a magnetic separator 101 according to another embodiment of the present invention. In the magnetic separator 101 according to another embodiment of the present invention, one end of the second scraper 12 is fixed to the outer peripheral surface of the sub-drum 3, and the other end is not fixed. For this reason, a gap is formed between the other end of the second scraper 12 and the first bottom wall 9, and this gap serves as an opening portion 16 through which the liquid to be treated in the lower flow path 14 flows. Further, the opening portion 16 is configured to send the liquid to be treated in the lower flow path 14 to the main drum 2.

Further, the other end of the second scraper 12 has a shape curved toward the main drum 2. According to this shape, the magnetic sludge conveyed by the flow of the liquid to be treated in the upper flow path 13 flows in the direction of the main drum 2 along the curved shape of the other end of the second scraper 12, and therefore, the effect of promoting the magnetic attraction of the magnetic sludge to the main drum 2 is exhibited.

Further, in the magnetic separator 101 according to another embodiment, a flow rate adjustment part 17 fixed to hang down from the top surface is provided in the interior of the main body 1. The flow rate adjustment part 17 is a member for adjusting the flow rate of the liquid to be treated in the upper flow path 13 and can set the flow rate of the liquid to be treated in the upper flow path 13 to be smaller than the flow rate of the liquid to be treated in the lower flow path 14. Further, according to this member, even in a case where the input amount of the liquid to be treated from the input part 4 increases, the flow rate of the liquid to be treated in the upper flow path 13 can be maintained in a state of being smaller than the flow rate of the liquid to be treated in the lower flow path 14.

Furthermore, the flow rate adjustment part 17 has a shape along the sub-drum 3 and forms a flow path between itself and the sub-drum 3. In this way, it is possible to still further promote the magnetic attraction of the magnetic sludge to the sub-drum 3.

### Method of Treating Liquid to be Treated Containing Magnetic Sludge

A method of separating and recovering the magnetic sludge from the liquid to be treated by using the magnetic separator according to an embodiment of the present invention is carried out by the following processes.

A method of treating the liquid to be treated containing the magnetic sludge by using the magnetic separator provided with the main drum which discharges the magnetic sludge to the outside of the liquid to be treated, and the sub-drum which is disposed on the upstream side of the main drum and magnetizes the magnetic sludge in the liquid to be treated includes:

(Process 1) a process of inputting the liquid to be treated into the magnetic separator;

(Process 2) a process of making the liquid to be treated input into the magnetic separator flow above the sub-drum;

(Process 3) a process of making the liquid to be treated input into the magnetic separator flow below the sub-drum; and

(Process 4) a process of making the magnetic sludge contained in the liquid to be treated flowing above the sub-drum flow with the liquid to be treated flowing above the sub-drum and the liquid to be treated flowing below the sub-drum joining each other.

Further, it is preferable that the above treatment method further includes:

(Process 5) a process of adjusting the flow rate of the liquid to be treated flowing below the sub-drum so as to become larger than the flow rate of the liquid to be treated flowing above the sub-drum.

The use of each configuration of the magnetic separator according to an embodiment of the present invention may be added as a process of the treatment method.

The magnetic separator according to an embodiment of the present invention is for recovering the magnetic sludge contained in the liquid to be treated by the magnetic force, and a high recovery rate is realized regardless of having an oily property or water solubility. As the liquid to be treated, for example, a coolant liquid in a metal grinding machine using magnetic metal as a workpiece, a plating solution in an apparatus of performing plating on a steel sheet, or the like can be given.

Further, the magnetic separator according to an embodiment of the present invention can be used as long as it separates magnetic sludge such as metal from a liquid. For example, the magnetic separator according to an embodiment of the present invention may be used for recovery of rare metal from industrial waste, removal of foreign matter from a beverage, edible oil, or the like, or the like.

It should be understood that the invention is not limited to the above-described embodiment, but may be modified into various forms on the basis of the spirit of the invention. Additionally, the modifications are included in the scope of the invention.

What is claimed is:

1. A magnetic separator comprising:
a scraper configured to channel a liquid through an opening portion to a flow pathway, the scraper extends from a sub-drum to the opening portion;
a first bottom wall configured to channel the liquid along the flow pathway in a manner that channels the liquid away from the opening portion, the flow pathway is between a main drum and a curved surface of the first bottom wall; and
a second bottom wall configured to channel the liquid along a lower flow path in a manner that channels the liquid to the opening portion, the lower flow path is between the sub-drum and a curved surface of the second bottom wall.

2. The magnetic separator according to claim 1, wherein the opening portion is between the main drum and the sub-drum.

3. The magnetic separator according to claim 1, wherein an intersection is where the first bottom wall comes into contact with the second bottom wall, the opening portion is between the scraper and the intersection.

4. The magnetic separator according to claim 1, wherein the curved surface of the first bottom wall is configured to come into contact with the liquid when the liquid is in the flow pathway.

5. The magnetic separator according to claim 1, wherein the curved surface of the second bottom wall is configured to come into contact with the liquid when the liquid is in the lower flow path.

6. The magnetic separator according to claim 1, wherein the main drum is configured to come into contact with the liquid when the liquid is in the flow pathway.

7. The magnetic separator according to claim 1, wherein the sub-drum is configured to come into contact with the liquid when the liquid is in the lower flow path.

8. The magnetic separator according to claim 1, wherein an end of the scraper is curved toward the main drum.

9. The magnetic separator according to claim 1, wherein the sub-drum is between the main drum and an input part, the input part is configured to input the liquid into the opening portion.

10. The magnetic separator according to claim 1, wherein the main drum and the sub-drum are configured to rotate in a same direction.

11. The magnetic separator according to claim 10, wherein the main drum is configured to rotate in a direction that is opposite to a flow of the liquid in the flow pathway.

12. The magnetic separator according to claim 10, wherein the sub-drum is configured to rotate in a direction that is opposite to a flow of the liquid in in the lower flow path.

13. The magnetic separator according to claim 1, wherein the sub-drum is between the lower flow path and an upper flow path.

14. The magnetic separator according to claim 13, wherein a flow of the liquid from the upper flow path is flowable to the flow pathway.

15. The magnetic separator according to claim 13, wherein the sub-drum is configured to come into contact with the liquid when the liquid is in the upper flow path.

16. The magnetic separator according to claim 13, wherein the lower flow path joins the upper flow path at the opening portion.

17. The magnetic separator according to claim 13, wherein the upper flow path is between the sub-drum and a flow rate adjustment part.

18. The magnetic separator according to claim 17, wherein a surface of the flow rate adjustment part is configured to come into contact with the liquid when the liquid is in the upper flow path.
